(19) United States
(12) Patent Application Publication
(10) Pub. No.: US 2022/0185529 A1
(43) Pub. Date: Jun. 16, 2022

(54) METHOD FOR MANUFACTURING A PAPERBOARD BOTTLE AND PAPERBOARD BOTTLE

(71) Applicant: Esbottle Oy, Espoo (FI)

(72) Inventor: Kaj PELAMO, Kirkkonummi (FI)

(73) Assignee: Esbottle Oy, Espoo (FI)

(21) Appl. No.: 17/433,166

(22) PCT Filed: Dec. 11, 2018
(86) PCT No.: PCT/FI2018/050898

§ 371 Date: Aug. 23, 2021

(51) Int. Cl. B65D 3/02; B65D 3/22; B65D 23/02; B67C 7/00; B29D 22/00; B31B 50/34; B31B 50/74; B31B 50/64; B31B 50/26; B31B 50/84

(52) U.S. Cl. CPC B65D 3/02; B65D 3/22; B65D 23/02; B67C 7/00; B29D 22/003; B31B 2110/20; B31B 50/743; B31B 50/644; B31B 50/262; B31B 50/84; B31B 50/34

(57) ABSTRACT

A method for manufacturing a paperboard bottle and spiral-wound paperboard bottle. The bottle has a tubular body portion, a shoulder and neck portion having a circular cross-section narrowing from the body portion to a circular mouth. The paperboard bottle is a liquid packaging board having thermoplastic polymer coating on both sides. The method includes cutting a planar elongated blank from a packaging board sheet. Protecting exposed cut raw edge of the first longitudinal edge against absorption of liquid. Securing the first end of the blank to a rotatable mandrel having a rotation axis (x) and an outer shape corresponding to the shape of the bottle. Rotating the mandrel to wind the blank spirally onto the mandrel, so that the longitudinal edges overlap applying heat-sealing energy and pressure, onto the overlapping longitudinal edges to form a bottle with hermetically sealed spiral seam and removing the mandrel from inside the bottle.

### FIELD OF THE INVENTION

The present invention relates to a method for manufacturing a paperboard bottle. Further, the present invention relates to a paperboard bottle having a tubular body portion, a shoulder and neck portion having a circular cross-section narrowing from the body portion to a circular mouth, the mouth having a smaller diameter than the body portion.

### BACKGROUND OF THE INVENTION

In prior art, as disclosed for example in documents U.S. Pat. Nos. 1,265,505, 1,265,506, 1,931,047, 1,969,889, 2,172,504, 2,267,993 and 2,323,078, there have been several attempts to produce a bottle having a tubular body portion, a shoulder and neck portion having a circular cross-section which narrows from the body portion to a circular mouth and said bottle is made from a piece of blank made of paper material. Primarily this kind of paper bottles are intended to be used as milk bottles. The prior art paper bottles have seams and pleats extending in the longitudinal direction of the bottle causing a drawback they are not suitable for containing carbonated drinks, such as carbonated beverages, alcohol and beer, which exert an internal pressure to the bottle because the seams and/or pleats do not withstand such an internal pressure. Therefore, bottles made of glass or plastics, or cans made of aluminum, are required to be used for packaging carbonated drinks.

### OBJECTIVE OF THE INVENTION

The objective of the invention is to alleviate the disadvantages mentioned above.

In particular, it is an objective of the present invention to provide a paperboard bottle which is able to withstand internal pressure and can be used as a container for carbonated drinks.

### SUMMARY OF THE INVENTION

According to a first aspect, the present invention provides a method for manufacturing a paperboard bottle having a tubular body portion, a shoulder and neck portion having a circular cross-section narrowing from the body portion to a circular mouth, the mouth having a smaller diameter than the body portion. According to the invention the paperboard bottle is made of a liquid packaging board having thermoplastic polymer coating on both sides, the method comprising steps of:
a) cutting a piece of planar elongated blank from a liquid packaging board sheet or web, the blank having a first end, a second end, a first longitudinal edge and a second longitudinal edge,
b) protecting exposed cut raw edge of the first longitudinal edge against absorption of liquid,
c) securing the first end of the blank to a rotatable mandrel having a rotation axis and an outer shape corresponding to the shape of the bottle to be manufactured,
d) rotating the mandrel about its rotation axis to wind the blank spirally onto the mandrel, so that the second longitudinal edge overlaps the longitudinal first edge, and
e) applying heat-sealing energy and pressure, while rotating the mandrel, onto the second longitudinal edge to seal the second longitudinal edge together with the first longitudinal edge to form a hermetically sealed spiral seam and to form a monolithic shape of the bottle, and
f) removing the mandrel from inside the bottle.

According to a second aspect, the present invention provides a paperboard bottle having a tubular body portion, a shoulder and neck portion having a circular cross-section narrowing from the body portion to a circular mouth, the mouth having a smaller diameter than the body portion. According to the invention the paperboard bottle is made as a monolithic structure of liquid packaging board having thermoplastic polymer layers on both sides, and that the paperboard bottle is a spiral-wound structure of a piece of planar longitudinal blank cut from said liquid packaging board and the bottle having a spiral seam.

The technical effect is that the spiral-wound structure of the paperboard bottle is able to withstand the internal pressure caused by a carbonated drink, such as carbonated beverage or beer or like, contained in the bottle containing carbon dioxide, which is the source of the pressure. The paperboard bottle of the invention is able to provide a long shelf-life without any leakages. The paperboard bottle has also all the advantages of sustainable packaging. The liquid packaging board is fully recyclable.

In an embodiment of the method, the method comprises a step of attaching a cap made of thermoplastic polymer onto the mouth of the bottle to form a hermetical sealing between the bottle and the cap.

In an embodiment of the method, the step of attaching a cap onto the mouth includes heat-sealing of the cap to the mouth.

In an embodiment of the method, heat-sealing of the cap to the mouth is made by ultrasonic welding.

In an embodiment of the method, the method comprises a step of injection molding a cap from thermoplastic polymer onto the mouth of the bottle.

In an embodiment of the method, the method comprises a step of filling liquid into the bottle via an open bottom, and thereafter securing a bottom piece made of liquid packaging board to cover the open bottom of the bottle.

In an embodiment of the method, the step of protecting the exposed cut raw edge of the first longitudinal edge includes hemming the first longitudinal edge of the blank to form a hemmed edge having an over-bent portion.

In an embodiment of the method, step of protecting the raw edge of the first longitudinal edge includes thinning a thinned strip along and near to the first longitudinal edge before hemming.

In an embodiment of the method, the step of securing includes winding the blank onto the mandrel so that the over-bent portion of the hemmed edge is directed away from the mandrel.

In an embodiment of the method, the step of rotating includes overlapping the hemmed edge of the first longitudinal edge by the second longitudinal edge.

In an embodiment of the method, the step of applying heat-sealing energy and pressure includes sealing the second longitudinal edge together with the hemmed edge of the first longitudinal edge.

In an embodiment of the method, the step of protecting the raw edge of the first longitudinal edge includes covering the raw edge with a strip of plastic foil or with an adhesive plastic tape.

In an embodiment of the paperboard bottle, the liquid packaging board of the bottle is a multilayer structure comprising one or more layers made of bleached sulphate pulp.

In an embodiment of the paperboard bottle, the liquid packaging board comprises a top layer made of bleached sulphate pulp, a middle layer made of chemi-thermomechanical pulp (CTMP), a back layer of made of bleached sulphate pulp and a polyethylene layer on the outer side of the top layer and/or the back layer.

In an embodiment of the paperboard bottle, the blank comprises a first longitudinal edge and a second longitudinal edge, and at the spiral seam the second longitudinal edge overlaps the first longitudinal edge.

In an embodiment of the paperboard bottle, the first longitudinal edge includes a hemmed edge having an over-bent portion.

In an embodiment of the paperboard bottle, at the spiral seam the over-bent portion is covered with the second longitudinal edge.

In an embodiment of the paperboard bottle, the hemmed edge comprises a thinned strip so that the thickness of the hemmed edge is substantially equal to the thickness of the liquid packaging board.

In an embodiment of the paperboard bottle, the cut raw edge of the first longitudinal edge is covered with a plastic foil or with an adhesive plastic tape.

It is to be understood that the aspects and embodiments of the invention described above may be used in any combination with each other. Several of the aspects and embodiments may be combined together to form a further embodiment of the invention.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 schematically shows a sheet of liquid packaging board wherein a plurality of blanks of one embodiment of the invention have been cut,

FIG. 2 schematically shows a web of liquid packaging board unwound from a reel a plurality of blanks of one embodiment of the invention have being cut from the web,

FIG. 3 shows a plan view of a blank for making a paperboard bottle according to one embodiment of the invention by a method according to one embodiment of the invention,

FIG. 4 illustrates a step of protecting the cut raw edge of the first longitudinal edge of the blank by forming a hemmed edge,

FIG. 5 illustrates a step of protecting cut raw edge of the first longitudinal edge of the blank by applying thereon a plastic foil or adhesive plastic tape,

FIGS. 6 to 8 show a step winding the blank spirally on the bottle-shaped mandrel to form a spiral-wound bottle,

FIG. 9 illustrates a step of attaching a bottle cap on the mouth of the spiral-wound paperboard bottle,

FIG. 10 illustrates a step of filling liquid into the bottle via an open bottom of the bottle,

FIG. 11 illustrates a step of securing by ultrasonic welding a bottom piece made of liquid packaging board to cover the open bottom of the bottle,

FIG. 12 shows a complete and paperboard bottle filled with liquid, and

FIGS. 13A, 13B and 13C show three alternatives for the spiral seam in section XIII-XIII from FIG. 12.

### DETAILED DESCRIPTION OF THE INVENTION

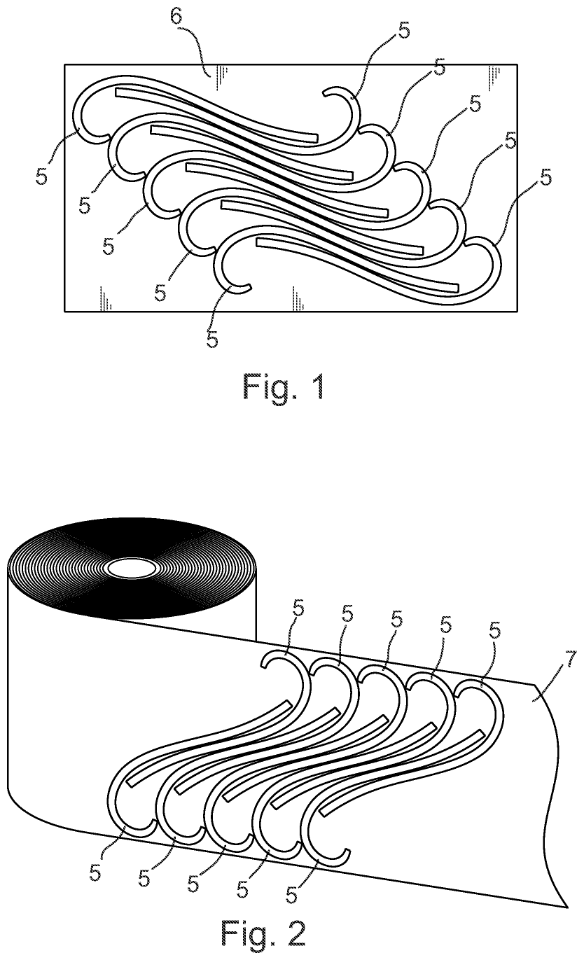

Reference is made to FIGS. 1 to 12. In the method a paperboard bottle 1 as shown in FIG. 12 is manufactured. The paperboard bottle 1 has a tubular body portion 2, a shoulder and neck portion 3 having a circular cross-section narrowing from the body portion 2 to a circular mouth 4. The mouth 4 has a smaller diameter than the body portion 2. The paperboard bottle is made of a liquid packaging board having thermoplastic polymer coating on both sides. The paperboard bottle 1 is a spiral-wound structure of a piece of planar longitudinal blank 5 cut from said liquid packaging board and having wound so that the bottle 1 has a spiral seam 1. For example, the liquid packaging board may be, for example, a multilayer structure comprising one or more layers made of bleached sulphate pulp. The liquid packaging board may comprise a top layer made of bleached sulphate pulp, a middle layer made of chemi-thermomechanical pulp CTMP, a back layer of made of bleached sulphate pulp and a polyethylene PE layer on the outer side of the top layer and/or the back layer. As the liquid packaging board can be used e.g. products of the Finnish company Stora Enso marketed with trademarks Natura™ 2PE Board or Natura™ Barr. Natura™ 2PE Board is a bleached liquid packaging board with a three-layer fibre construction, with two outer layers made of bleached sulphate pulp and a middle layer made of CTMP (chemi-thermo-mechanical pulp). Its top and reverse sides are polyethylene PE coated. Natura™ Barr is a bleached liquid packaging board with a three-layer fibre construction, with two outer layers made of bleached sulphate pulp and a middle layer made of CTMP (chemi-thermo-mechanical pulp). It has a polyethylene PE coating on the top side and a multilayer high-barrier coating on the reverse side.

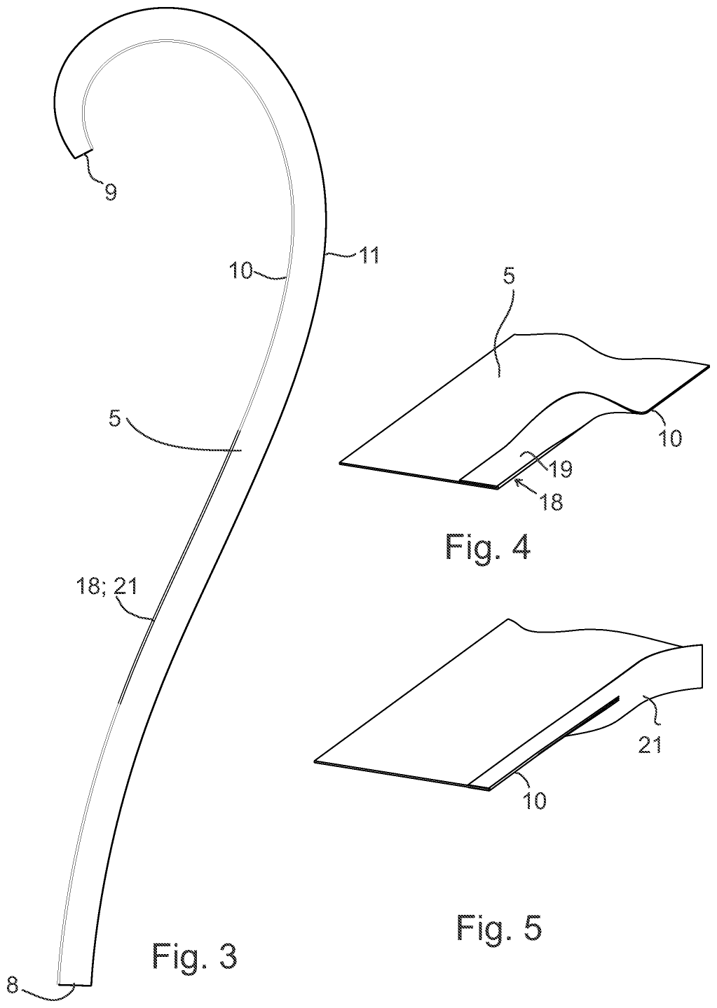

In the method, a piece of planar elongated blank 5 is cut from a liquid packaging board sheet 6 (see FIG. 1) or web 7 (see FIG. 2). Referring to FIG. 3, the blank 5 has a first end 8, a second end 9, a first longitudinal edge 10 and a second longitudinal edge 11. The blank 5 has a curved shape as shown in FIG. 3. The exposed cut raw edge of the first longitudinal edge is protected against absorption of liquid. This can be done in a manner as shown in FIGS. 4 and 13A and 13B whereby the first longitudinal edge of the blank 5 is hemmed to form a hemmed edge 18 having an over-bent portion 19. Before hemming, a thinned strip 20 can be skived along and near to the first longitudinal edge 10, so that the thickness of the hemmed edge 18 is substantially equal to the thickness of the liquid packaging board, as shown in FIG. 13B. An another manner of protecting the exposed cut raw edge of the first longitudinal edge 10 against absorption of liquid is shown in FIGS. 5 and 13C wherein the cut raw edge of the first longitudinal edge 10 is covered with a strip of plastic foil or with an adhesive plastic tape 21.

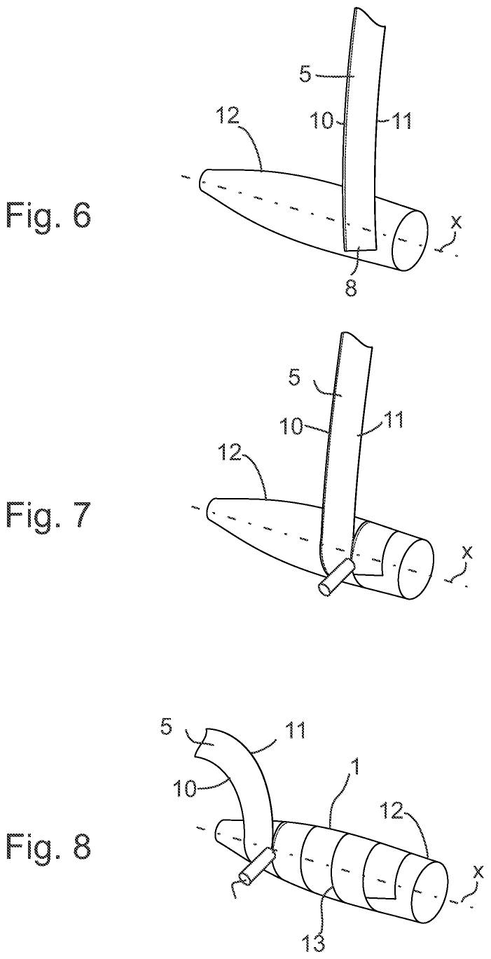

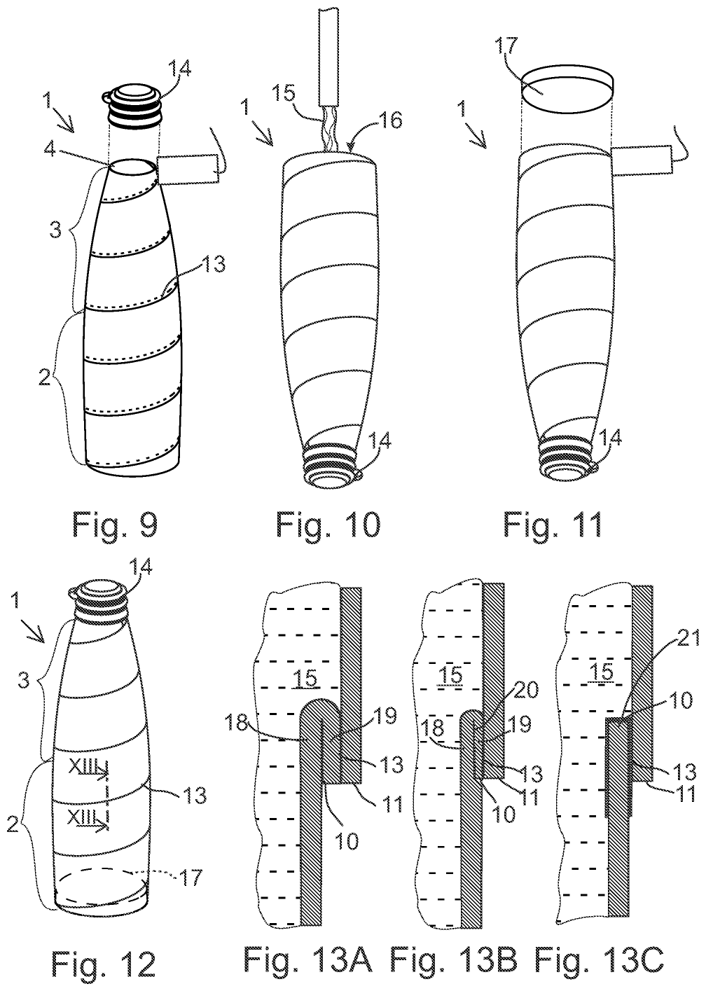

The next step in the method is shown in FIGS. 6 to 8. The first end 8 of the blank 5 is secured to a rotatable mandrel 12 having a rotation axis x and an outer shape corresponding to the shape of the bottle 1 to be manufactured. The mandrel 12 is rotated about its rotation axis x to wind the blank 5 spirally onto the mandrel 12, so that the second longitudinal edge 11 overlaps the protected longitudinal first edge 10. The over-bent portion 19 of the hemmed edge 18 is directed away from the mandrel 12 and the hemmed edge 18 of the first longitudinal edge 10 is overlapped by the second longitudinal edge 11. At the same time while rotating the mandrel 12 heat-sealing energy and pressure is applied onto the second longitudinal edge 11 to seal the second longitudinal edge 11 together with the first longitudinal edge to form a hermetically sealed spiral seam 13 and to form a monolithic shape of the bottle 1. After the winding process is completed, the mandrel 12 is removed from inside the bottle 1. As shown in FIG. 9, after or before removing the mandrel, a cap 14 made of thermoplastic polymer or other suitable material is attached onto the mouth 4 of the bottle 1 to form a hermetical sealing between the bottle and the cap. The cap 14 may be heat-sealed by ultrasonic welding to the mouth 4 of the bottle 1. Alternatively, the cap 14 may be injection molded from thermoplastic polymer or similar injection moldable material onto the mouth 4 of the bottle 1. As shown in FIG. 10, after the cap 14 has been secured to the bottle 1, the bottle is turned upside down so that the open bottom 16 is directed upwardly. Liquid 15 filled into the bottle 1 via the open bottom 16. As shown in FIG. 11, thereafter a bottom piece 17 made of liquid packaging board is secured to cover the open bottom of the bottle. Preferably, the bottom piece 17 is heat-sealed to the body of the bottle 1 by ultrasonic welding to form a hermetically sealed seam. When the liquid 15 is carbonated drink, the bottom piece 17 has a concave cup-like shape to be able to withstand the internal pressure.

While the present inventions have been described in connection with a number of exemplary embodiments, and implementations, the present inventions are not so limited, but rather cover various modifications, and equivalent arrangements, which fall within the purview of prospective claims.

1. A method for manufacturing a paperboard bottle having a tubular body portion, a shoulder and neck portion having a circular cross-section narrowing from the body portion to a circular mouth, the mouth having a smaller diameter than the body portion, wherein the paperboard bottle is made of a liquid packaging board having thermoplastic polymer coating on both sides, the method comprising steps of:
a) cutting a piece of planar elongated blank from a liquid packaging board sheet or web, the blank having a first end, a second end, a first longitudinal edge and a second longitudinal edge,
b) protecting exposed cut raw edge of the first longitudinal edge against absorption of liquid,
c) securing the first end of the blank to a rotatable mandrel having a rotation axis (x) and an outer shape corresponding to the shape of the bottle to be manufactured,
d) rotating the mandrel about its rotation axis (x) to wind the blank spirally onto the mandrel, so that the second longitudinal edge overlaps the longitudinal first edge, and
e) applying heat-sealing energy and pressure, while rotating the mandrel, onto the second longitudinal edge to seal the second longitudinal edge together with the first longitudinal edge to form a hermetically sealed spiral seam and to form a monolithic shape of the bottle, and
f) removing the mandrel from inside the bottle.

2. The method according to claim 1, wherein the method comprises after step f) a step of attaching a cap made of thermo-plastic polymer onto the mouth of the bottle to form a hermetical sealing between the bottle and the cap.

3. The method according to claim 2, wherein the step of attaching a cap onto the mouth includes heat-sealing of the cap to the mouth.

4. The method according to claim 3, wherein heat-sealing of the cap to the mouth is made by ultrasonic welding.

5. The method according to, claim 1, wherein the method comprises a step of injection molding a cap from thermoplastic polymer onto the mouth of the bottle.

6. The method according to claim 1, wherein the method comprises a step of filling liquid into the bottle via an open bottom, and thereafter securing a bottom piece made of liquid packaging board to cover the open bottom of the bottle.

7. The method according to claim 1, wherein the step of protecting the exposed cut raw edge of the first longitudinal edge includes hemming the first longitudinal edge of the blank to form a hemmed edge having an over-bent portion.

8. The method according to claim 7, wherein the step of protecting the raw edge of the first longitudinal edge includes thinning a thinned strip along and near to the first longitudinal edge before hemming.

9. The method according to claim 7, wherein the step of securing includes winding the blank onto the mandrel so that the overbent portion of the hemmed edge is directed away from the mandrel.

10. The method according to claim 7, wherein the step of rotating includes overlapping the hemmed edge of the first longitudinal edge by the second longitudinal edge.

11. The method according to claim 7, wherein the step of applying heat-sealing energy and pressure includes sealing the second longitudinal edge together with the hemmed edge of the first longitudinal edge.

12. The method according to claim 1, wherein the step of protecting the raw edge of the first longitudinal edge includes covering the raw edge with a strip of plastic foil or with an adhesive plastic tape.

13. A paperboard bottle having a tubular body portion, a shoulder and neck portion having a circular cross-section narrowing from the body portion to a circular mouth, the mouth having a smaller diameter than the body portion, wherein the paperboard bottle is made as a monolithic structure of liquid packaging board having thermoplastic polymer layers on both sides, and that the paperboard bottle is a spiral-wound structure of a piece of planar longitudinal blank cut from said liquid packaging board and the bottle having a spiral seam.

14. The paperboard bottle according to claim 13, wherein the liquid packaging board of the bottle is a multilayer structure comprising one or more layers made of bleached sulphate pulp.

15. The paperboard bottle according to claim 13, wherein the liquid pack-aging board comprises a top layer made of bleached sulphate pulp, a middle layer made of chemi-thermomechanical pulp (CTMP), a back layer of made of bleached sulphate pulp and a polyethylene (PE) layer on the outer side of the top layer and/or the back layer.

16. The paperboard bottle according to claim 13, wherein the blank comprises a first longitudinal edge and a second longitudinal edge, and at the spiral seam the second longitudinal edge overlaps the first longitudinal edge.

17. The paperboard bottle according to claim 13, wherein the first longitudinal edge includes a hemmed edge having an over-bent portion.

18. The paperboard bottle according to claim 13, wherein at the spiral seam the over-bent portion is covered with the second longitudinal edge.

19. The paperboard bottle according to claim 13, wherein the hemmed edge comprises a thinned strip so that the thickness of the hemmed edge is substan-tially equal to the thickness of the liquid packag-ing board.

20. The paperboard bottle according to claim 13, wherein the cut raw edge of the first longitudinal edge is covered with a plastic foil or with an adhesive plastic tape.
